(19) United States
(12) Patent Application Publication
(10) Pub. No.: US 2008/0202852 A1
(43) Pub. Date: Aug. 28, 2008

(54) Stowable boat ladder

(76) Inventor: Joseph Zsido, Benton, IL (US)

Correspondence Address: WOOD, PHILLIPS, KATZ, CLARK & MORTIMER, 500 W. MADISON STREET, SUITE 3800, CHICAGO, IL, 60661, US

(21) Appl. No.: 11/711,427

(22) Filed: Feb. 27, 2007

(51) Int. Cl. E06C 5/00

(52) U.S. Cl. 182/129; 114/363; 182/97

(57) ABSTRACT

A stowable ladder for a boat deck, including a base plate securable to the underside of a boat, a rotary plate secured for pivoting about an axis relative to the base plate (with the axis being generally vertical when the base plate is secured to a boat underside), a bracket on the underside of the rotary plate, and a swim ladder secured to the bracket. The ladder is movable relative to the bracket between a stowed position generally parallel to the rotary plate and a usable position depending downwardly therefrom in a generally vertical position. A latch secures the rotary plate relative to the base plate whereby the ladder in the stowed position extends generally transverse to the keel of the boat when secured thereto, and pivots between about 60° to 120° relative to the base plate when moving between the stowed position and the usable position.

### CROSS REFERENCE TO RELATED APPLICATION(S)

Not applicable.

### STATEMENT REGARDING FEDERALLY SPONSORED RESEARCH OR DEVELOPMENT

Not applicable.

### REFERENCE TO A MICROFICHE APPENDIX

Not applicable.

### TECHNICAL FIELD

The present invention relates to a boat ladder, and more particularly to a boat ladder which may be secured to a boat and moved between a stowed, out-of-the-way position and a usable position which swimmers may use to assist in getting on the boat.

### BACKGROUND OF THE INVENTION AND TECHNICAL PROBLEMS POSED BY THE PRIOR ART

Pleasure watercraft are well known for use in fishing, skiing, waterboarding, and other water activities, as well as simple leisurely travel on waterways, whether for the sheer fun of being in the outdoors in that environment or to reach areas where they can enjoy swimming without the usual crowds found on beaches.

In many of these activities, persons on the boat may intentionally or unintentionally leave the boat and go into the water. When that occurs, it is desirable to have a ladder available to the person in the water which they can use to help them get back into the boat, understanding that this often occurs at water depths which do not allow the person to stand while they are trying to get into the boat.

Many such ladder structures have been provided to provide this convenience. Some ladder structures permanently or temporarily are secured to the side of the boat and project outwardly from the boat hull. In those cases, the ladder may be subject to damage if, for example, bumped against a pier, or may require more expensive manufacture to ensure that it is protected from such damage. Removable ladders allow that risk to be avoided, but can occupy space in the limited boat cabin area when not in use. Further, if a person leaves the boat without remembering to (or being able to) deploy such removable ladders, the person in the water may be required to attempt to get back into the boat without the benefit of any ladder.

The present invention is directed toward overcoming one or more of the problems set forth above.

### SUMMARY OF THE INVENTION

In one aspect of the present invention, a stowable ladder for a boat deck is provided, including a base plate securable to the underside of a boat, a rotary plate secured for pivoting about an axis relative to the base plate, the axis being generally vertical when the base plate is secured to a boat underside, a bracket on the underside of the rotary plate, and a swim ladder secured to the bracket. The ladder is movable relative to the bracket between a stowed position generally parallel to the rotary plate and a usable position depending downwardly therefrom in a generally vertical position.

In one form of this aspect of the present invention, a latch is provided for securing the rotary plate relative to the base plate whereby the ladder in the stowed position extends generally transverse to the keel of the boat when secured thereto. In a further form, the rotary plate pivots between about 60° to 120° relative to the base plate when moving between the stowed position and the usable position, and in a still further form the rotary plate pivots about 110° relative to the base plate when moving between the stowed position and the usable position. In a still further form, at least one curved slot is in the rotary plate, wherein the slot is centered at a selected radius from the axis and extends about 60° to 120° around the axis, and a pin is fixed to the base plate at the selected radius from the axis, with the pin extending into the curved slot.

In another form of this aspect of the present invention, the rotary plate pivots between about 60° to 120° relative to the base plate when moving between the stowed position and the usable position, and in a further form the rotary plate pivots about 110° relative to the base plate when moving between the stowed position and the usable position. In a still further form, at least one curved slot is in the rotary plate, wherein the slot is centered at a selected radius from the axis and extends about 60° to 120° around the axis, and a pin is fixed to the base plate at the selected radius from the axis, with the pin extending into the curved slot.

In still another form of this aspect of the present invention, the bracket defines a track substantially parallel to the rotary plate, and the swim ladder on one end is secured to slide in the track. In a still further form, the ladder one end is pivotable relative to the track, and a cross support is adapted to support the ladder in its stowed position with the ladder one end at one end of the track, wherein the ladder is substantially clear of the cross support when the ladder one end is at the other end of the track allowing the ladder to pivot downwardly to the usable position.

In yet another form of this aspect of the present invention, an angled plate is adapted to engage the ladder adjacent the rotary plate when the ladder is in the usable position whereby the ladder is in a generally vertical position but tilted toward the boat at its upper end.

In another aspect of the present invention, a stowable ladder for a boat deck is provided, including a base plate securable to the underside of a boat, a rotary plate secured for pivoting about an axis relative to the base plate (with the axis being generally vertical when the base plate is secured to a boat underside), and a bracket on the underside of the rotary plate defining a track substantially parallel to the rotary plate. A swim ladder has one end slidably secured to the track and pivotable relative to the track, with the ladder being movable relative to the bracket between a stowed position generally parallel to the rotary plate and a usable position depending downwardly therefrom in a generally vertical position. A cross support is adapted to support the ladder in its stowed position with the ladder one end at one end of the track, wherein the ladder is clear of the cross support when the ladder one end is at the other end of the track allowing the ladder to pivot downwardly to the usable position. An angled plate is adapted to engage the ladder adjacent the rotary plate when the ladder is in the usable position whereby the ladder is in a generally vertical position but tilted toward the boat at its upper end.

In one form of this aspect of the present invention, the rotary plate pivots between about 60° to 120° relative to the base plate when moving between the stowed position and the usable position. In a further form, at least one curved slot is in the rotary plate, wherein the slot is centered at a selected radius from the axis and extends about 60° to 120° around the axis, and a pin is fixed to the base plate at the selected radius from the axis, which pin extends into the curved slot. In another further form, a latch is provided for securing the rotary plate relative to the base plate whereby the ladder in the stowed position extends generally transverse to the keel of the boat when secured thereto.

### BRIEF DESCRIPTION OF THE DRAWINGS

FIG. 1 is a perspective view of a stowable boat ladder according to the present invention, with the ladder in a usable position beneath a boat swim deck shown in phantom;

FIG. 2 is a perspective view from beneath of the FIG. 1 boat ladder in an intermediary position while being changed to a stowed position;

FIG. 3 is a perspective view from beneath of the FIG. 1 boat ladder in a stowed position;

FIG. 4 is an exploded view of the FIG. 1 boat ladder;

FIG. 5 is a perspective, partially broken view of the plate members of the ladder base locked in the usable position;

FIG. 6 is a perspective, partially broken view of the plate members of the ladder base as manually unlocked while in the usable position prior to moving to the stowed position; and

FIG. 7 is a perspective, partially broken view of the plate members of the ladder base as unlocked in the stowed position.

### DETAILED DESCRIPTION OF THE INVENTION

A stowable ladder 10 usable, for example, with a boat is variously illustrated in the Figures.

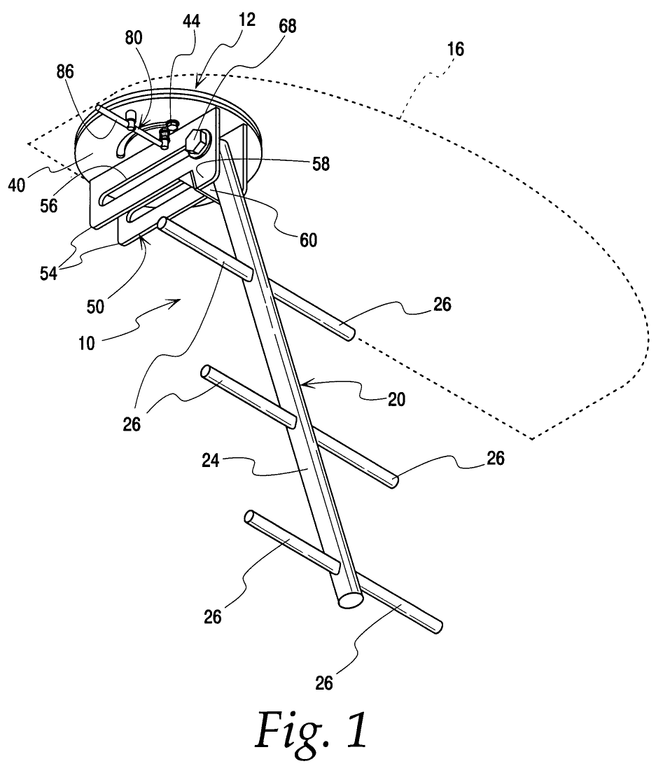

The ladder 10 includes a base 12 adapted to be secured to the underside of a boat, such as the underside of a boat swim deck 16 (illustrated in phantom in FIG. 1) provided at the aft end of a boat.

A swim ladder 20 includes a center rail 24 pivotably secured on one end to the base 12 as described in greater detail herein. Appropriately spaced rungs 26 extend from opposite sides of the center rail 24, which rungs 26 allow a swimmer to climb up out of the water and into the boat. Suitable rails or other structures (not shown) may also be provided above the ladder 10 on the boat which a swimmer climbing the swim ladder 20 may grasp to steady themselves as their feet reach the top rungs 26 of the swim ladder 20 (in which position swimmers will, of course, be unable to steady themselves by grasping the ladder rungs 26 with their hands).

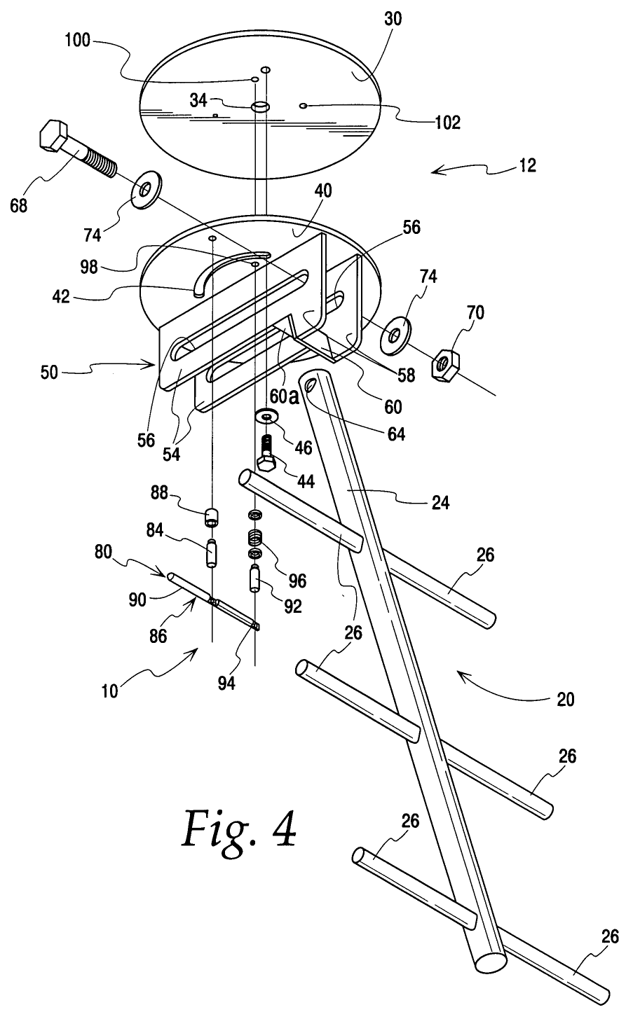

As best illustrated in FIG. 4, the base 12 includes a base plate 30 which is suitably securable to the underside of a boat as previously mentioned, and a rotary plate 40 which is suitably secured to the base plate 30 for pivoting about an axis relative to the base plate 12. For example, the base plate 12 may include a cylindrical opening 34 centered on the pivot axis which receives a cylindrical projection (not shown) on the top of the rotary plate 40 whereby the rotary plate 40 is thereby guided for smooth pivoting about the axis. It should be appreciated, however, that it would be within the scope of the present invention to use any structure which suitably secures the rotary plate 40 to the base plate 30 so that pivoting of the rotary plate 40 is allowed.

When secured to a boat underside, the base plate 30 has a generally horizontal orientation and the pivot axis is generally vertical.

In one advantageous embodiment, the rotary plate 40 may include a curved or arcuate slot 42 centered on the pivot axis, with a suitable bolt 44 extending through the slot 42 and secured to the base plate 30. The bolt 44 may advantageously also include a washer 46 between its head and the rotary plate 40, and the bolt 44 is not tightened against the rotary plate 40 so that when the rotary plate 40 is pivoted, its arcuate slot 42 moves past the bolt 44, with the bolt 44 serving as a stop to limit the amount of rotation of the rotary plate 40 relative to the base plate 30. The arcuate slot 42 may extend about 60° to 120° around the pivot axis, with the pivoting through a range of about 110° being advantageously permitted in one embodiment.

A bracket 50 used to connect the swim ladder 20 to the base 12 extends from the underside of the rotary plate 40.

An advantageous bracket 50 is illustrated in the embodiment shown in the Figures, and includes a pair of parallel bracket plates 54 extending down from the rotary plate 40 (in a generally vertical orientation when secured to the bottom of a swim deck as previously described). The plates 54 each include parallel (generally horizontal) slots 56, and on one end include downwardly extending flanges 58 which are connected by a brace plate 60 which is generally vertical but advantageously may be angled slightly relative to vertical such as shown in the Figures.

The center rail 40 of the swim ladder 20 is secured on one end to the bracket 50 such that, as described in greater detail below, it is movable relative to the bracket 50 and rotary plate 40 between a stowed position generally parallel to the rotary plate 40 and a usable position depending downwardly from the rotary plate 40 in a generally vertical position.

Specifically, in the illustrated embodiment, the upper end of the swim ladder 20 includes a transverse opening 64. A pivot bolt 68 extends. The bolts 64 also extends through the slots 56 and the transverse opening 64 and is suitably secured in that position, for example, by a locking nut 70 as shown. It should thus be appreciated that the upper end of the swim ladder 20 is pivotable relative to the bracket 50, and also may slide horizontally as guided by the bolt 68 in the bracket slots 56. Suitable washers 74 may be provided with the bolt 68 to assist in preventing binding of the bolt 68 during such motion.

Deployment of the swim ladder 20 to a usable position for swimming (as illustrated in FIG. 1) should thus be appreciated. In the usable position, the upper end of the swim ladder 20 is at the end of the slots 56 adjacent the bracket plate flanges 58, with the swim ladder 20 thus hanging down in a generally vertical, but slightly outwardly tilted, position. As can be appreciated in FIG. 1, the weight of the swim ladder 20 causes it to hang down from the bolt 68 connection to the bracket plate slots 56, with the brace plate 60 supporting the swim ladder center rail 24 at a slight tilt. Such tilt not only orients the ladder 20 at a desirable slight tilt for climbing of the swim ladder 20, but it also serves to cause the ladder 20 to be steady (due to the weight of the ladder and a user holding the ladder 20 against the brace plate 60) so that the ladder 20 does not undesirably swing freely when used.

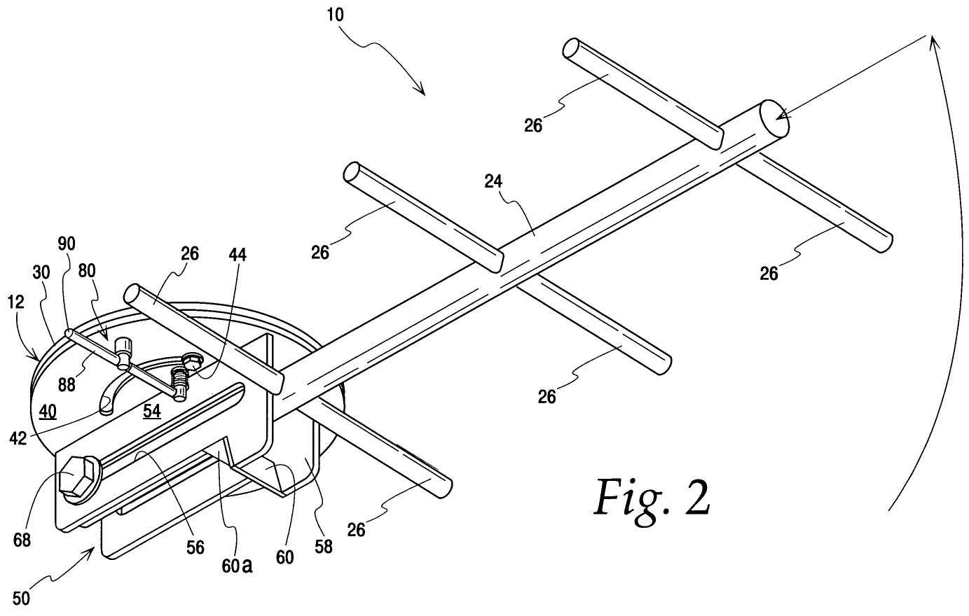

When moved from the usable position to a stowed position, the swim ladder 20 is first pivoted up around the bolt 68 to a generally horizontal position, and then moved longitudinally (relative to the center rail 24) to slide the bolt 68 connection to the other end of the bracket slots 56, as illustrated in FIG. 2. In that stowed position, the swim ladder 20 is supported horizontally by the bolt 68 connection on one end and by the brace plate 60 on an intermediate point. (The brace plate 60 may include a horizontal portion 60a, such as shown in FIGS. 2 and 4, to facilitate such intermediate support and to prevent high point stresses on the center rail 24.) It should be appreciated that this movement may be readily accomplished by a user reaching down from the boat (swim deck) and then first pulling up the swim ladder and then pulling it toward the boat to slide the center rail horizontally the length of the slots 56.

A suitable securing structure, such as a notch in the slot 56, or a detent structure, may also be provided to keep the swim ladder 20 from freely sliding horizontally back toward its usable position when intended to be stowed.

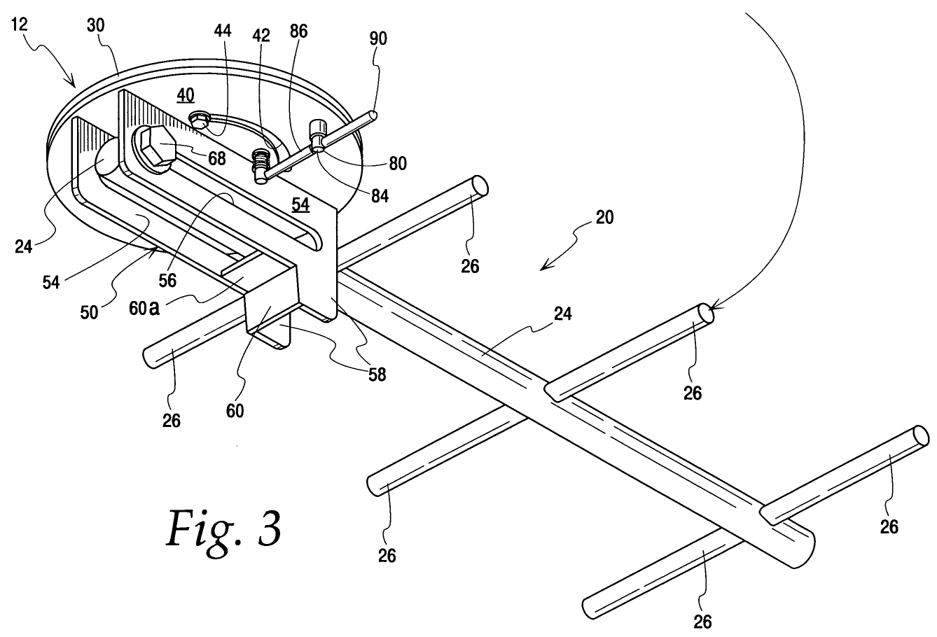

From the intermediate position of FIG. 2 (in which the swim ladder 20 will be oriented generally horizontally and extending outwardly from the boat, the rotary plate 40 may then be pivoted as shown in FIG. 3 whereby the swim ladder 20 will be in a stowed position extending transversely beneath the boat.

A latch 80 is also provided for releasably securing the rotary plate 40 relative to the base plate 30, with the swim ladder 20 releasably securable in the stowed position so as to extend generally transverse to the keel of the boat when secured thereto as previously mentioned, and the swim ladder 20 releasably securable in the usable position so as to tilt outwardly from the boat swim deck or the like as illustrated in FIG. 1.

The latch 80 of the embodiment illustrated in FIG. 4 includes a base support 84 suitably fixed to the rotary plate 40, with a lever arm 86 suitably secured at an intermediate location to the bottom end of the support 84 for pivoting relative thereto. A spacer or the like 88 may be provided to ensure proper support for the lever arm 86 spaced from the rotary plate 40.

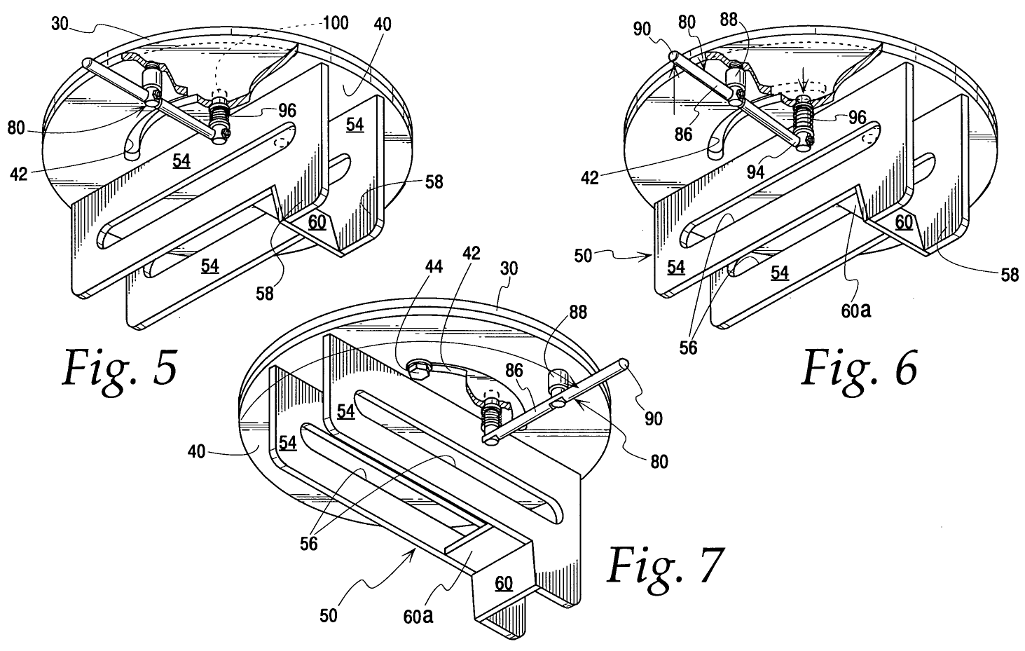

One end 90 of the lever arm 86 projects outwardly beyond the base plate 30 so that a person looking down past the base plate 30 would be able to see the lever end 90. A locking pin 92 is pivotally secured to the opposite end 94 of the lever arms 88, and includes a tension spring 96 which is anchored at opposite ends to the lever arm 86 and the rotary plate 40. The other (upper) end of the locking pin 92 passes through an opening 98 in the rotary plate 40. In its normal configuration, the tension spring 96 serves to pull the locking pin 92 and attached lever end 94 up (toward the rotary plate 40) and, when in either the usable or the stowed position, the locking pin 92 will be aligned with and extend into an opening 100 or 102 in the base plate 30. Thus, when in the usable position, the rotary plate 40 is releasably fixed against rotation by the extension of the locking pin 92 into the opening 100 as shown in FIG. 5.

From the usable position, the swim ladder 20 can thus be pivoted up and slid in as illustrated from FIGS. 1 to 2, at which point a user on the boat can lean over any grasp and pull up on the lever end 90, thereby pulling the other lever end 94 and attached locking pin 92 down so that the locking pin 92 is retracted from the opening 100 (as illustrated in FIG. 6). The rotary plate 40 may then be freely pivoted from the usable position to the stowed position (see FIGS. 3 and 7), in which the locking pin 92 will be aligned with the other base plate opening 102 and thereby snapped into place by the tension spring 96. The ladder will thus be fixed in the stowed position until a user again pulls up on the lever end 90, freeing the rotary plate 40 to rotate back to its usable position, where the swim ladder 20 may be pulled out and pivoted down to return it to the FIG. 1 configuration for use.

It should thus be appreciated that the ladder 10 of the present invention may be easily installed with a boat and readily used by the boat owner. The ladder 10 not only provides convenient and easy access to a boat for someone in the water. In fact, even if in the stowed position, a person in the water could easily deploy the ladder 10 to change to the usable position. Moreover, it should be particularly appreciated that the ladder 10 will be stowed completely out of the way when not used (without occupying limited storage space inside the boat), while at the same time always being ready for use if needed (thereby avoiding a possible problem for a person who dives from the boat to take a swim without remembering to first deploy a ladder to use in getting back in the boat).

Still other aspects, objects, and advantages of the present invention can be obtained from a study of the specification, the drawings, and the appended claims. It should be understood, however, that the present invention could be used in alternate forms where less than all of the objects and advantages of the present invention and preferred embodiment as described above would be obtained.

1. A stowable ladder for a boat deck, comprising:
a base plate securable to the underside of a boat;
a rotary plate secured for pivoting about an axis relative to said base plate, said axis being generally vertical when said base plate is secured to a boat underside;
a bracket on the underside of said rotary plate; and
a swim ladder secured to said bracket, said ladder being movable relative to said bracket between a stowed position generally parallel to said rotary plate and a usable position depending downwardly therefrom in a generally vertical position.

2. The ladder of claim 1, further comprising a latch for securing said rotary plate relative to said base plate whereby said ladder in said stowed position extends generally transverse to the keel of the boat when secured thereto.

3. The ladder of claim 2, wherein said rotary plate pivots between about 60° to 120° relative to said base plate when moving between said stowed position and said usable position.

4. The ladder of claim 3, wherein said rotary plate pivots about 110° relative to said base plate when moving between said stowed position and said usable position.

5. The ladder of claim 3, further comprising:
at least one curved slot in said rotary plate, wherein said slot is centered at a selected radius from said axis and extends about 60° to 120° around said axis; and
a pin fixed to said base plate at said selected radius from said axis, said pin extending into said curved slot.

6. The ladder of claim 1, wherein said rotary plate pivots between about 60° to 120° relative to said base plate when moving between said stowed position and said usable position.

7. The ladder of claim 6, wherein said rotary plate pivots about 110° relative to said base plate when moving between said stowed position and said usable position.

8. The ladder of claim 6, further comprising:
at least one curved slot in said rotary plate, wherein said slot is centered at a selected radius from said axis and extends about 60° to 120° around said axis; and
a pin fixed to said base plate at said selected radius from said axis, said pin extending into said curved slot.

9. The ladder of claim 1, wherein said bracket defines a track substantially parallel to said rotary plate, and said swim ladder on one end is secured to slide in said track.

10. The ladder of claim 9, wherein said ladder one end is pivotable relative to said track, and further comprising a cross support adapted to support said ladder in its stowed position with said ladder one end at one end of said track, wherein said ladder is substantially clear of said cross support when said ladder one end is at the other end of said track allowing said ladder to pivot downwardly to said usable position.

11. The ladder of claim 1, further comprising an angled plate adapted to engage said ladder adjacent said rotary plate when said ladder is in said usable position whereby said ladder is in a generally vertical position but tilted toward said boat at its upper end.

12. A stowable ladder for a boat deck, comprising:
a base plate securable to the underside of a boat;
a rotary plate secured for pivoting about an axis relative to said base plate, said axis being generally vertical when said base plate is secured to a boat underside;
a bracket on the underside of said rotary plate defining a track substantially parallel to said rotary plate;
a swim ladder having one end slidably secured to said track and pivotable relative to said track, said ladder being movable relative to said bracket between a stowed position generally parallel to said rotary plate and a usable position depending downwardly therefrom in a generally vertical position;
a cross support adapted to support said ladder in its stowed position with said ladder one end at one end of said track, wherein said ladder is clear of said cross support when said ladder one end is at the other end of said track allowing said ladder to pivot downwardly to said usable position; and
an angled plate adapted to engage said ladder adjacent said rotary plate when said ladder is in said usable position whereby said ladder is in a generally vertical position but tilted toward said boat at its upper end.

13. The ladder of claim 12, wherein said rotary plate pivots between about 60° to 120° relative to said base plate when moving between said stowed position and said usable position.

14. The ladder of claim 13, further comprising:
at least one curved slot in said rotary plate, wherein said slot is centered at a selected radius from said axis and extends about 60° to 120° around said axis; and
a pin fixed to said base plate at said selected radius from said axis, said pin extending into said curved slot.

15. The ladder of claim 13, further comprising a latch for securing said rotary plate relative to said base plate whereby said ladder in said stowed position extends generally transverse to the keel of the boat when secured thereto.
